(19) United States
(12) Patent Application Publication
(10) Pub. No.: US 2009/0259546 A1
(43) Pub. Date: Oct. 15, 2009

(54) Method of Incentive Distribution For Cross Client Referral

(76) Inventor: Allen Draper, Peabody, MA (US)

Correspondence Address: LAMBERT & ASSOCIATES, P.L.L.C., 92 STATE STREET, BOSTON, MA, 02109-2004, US

(21) Appl. No.: 12/252,449

(22) Filed: Oct. 16, 2008

Related U.S. Application Data
(60) Provisional application No. 60/985,280, filed on Nov. 4, 2007.

(51) Int. Cl. G06Q 30/00; G06F 17/30

(52) U.S. Cl. 705/14.16; 707/104.1; 707/200; 707/3; 707/E17.005; 707/E17.044; 707/E17.108

(57) ABSTRACT

The present invention relates generally to methods of generating business by providing incentives for clients to obtain goods and/or services from goods and service providers, wherein said providers refer clients to other providers and as said providers have incentives provided within the method to make said referrals. The method involves one central manager serving as a communications conduit among goods and service providers pooling their services into one joint goods and services cross-client referral cooperative group. The method provides an incentive system among group members for referring clients to other group members.

This application claims priority to and claims the benefit of the previously filed U.S. provisional patent application, U.S. Application No. 60/985,280, filed on Nov. 4, 2007

### FIELD OF THE INVENTION

The present invention relates generally to methods of generating business by providing incentives for clients to obtain goods and/or services from goods and service providers, wherein said providers refer clients to other providers and as said providers have incentives provided within the method to make said referrals.

### BACKGROUND OF INVENTION

This invention relates to methods of providing incentives to clients to obtain goods and/or services and to continue to obtain goods and services. Further this method also relates to methods that provide incentives to providers of goods and services to refer clients to other providers of goods and services.

Throughout history, merchants and service providers have employed various methods to improve their customer flow. These include sales and other types of price related promotions (buy-one-get-one-free promotions for instance), gimmicks including embellished demonstrations of properties and effects of various goods and services, and advertising including its many forms expressed in audio-visual and written forms.

Another, more passive, method of obtaining clients and customers includes obtaining referrals from others. This often is done simply out of good will of the referring party to provide good advice to the referee, so that they may obtain the quality of goods and services that they desire. However, merchants and service providers often do tie in incentives with their referrals. In some instances, a fee may be given to the referring party to induce them to make as many referrals as possible. Other incentives tied to referrals include the mutual understanding that they are more likely to receive their own client referrals from a party if they in turn refer clients to said party. This mutual understanding at times may take on implicit or even explicit forms.

In more recent times, the process of seeking Client's has employed a new tool—the Internet. At this time Internet advertising has become not only common, but routine and referrals are made by sharing links and emails.

### SUMMARY OF THE INVENTION

The instant invention, as illustrated herein, is clearly not anticipated, rendered obvious, or even present in any of the prior art mechanisms, either alone or in any combination thereof. A method of incentive distribution for cross client referrals that is facilitated by a central manager that uses computers across a network such as the Internet to serve as a central hub for users to send and receive client referrals would have several competitive advantages. Thus the several embodiments of the instant invention are illustrated herein.

Therefore, it is an object of the present invention to overcome the previously mentioned shortcomings found in prior client generating/client referral systems and provide a method of incentive distribution for cross client referrals.

It is another object of the present invention to provide a method of incentive distribution for cross client referrals that allows a plurality of service providers to find other service providers that their client(s) may be interested in pursuing.

It is another object of the present invention to provide a method of incentive distribution for cross client referrals that promotes a service provider's own services.

It is another object of the present invention to provide a method of incentive distribution for cross client referrals that provides at least one incentive for clients of one service provider to accept the services of another service provider.

It is another object of the present invention to provide a method of incentive distribution for cross client referrals that provides clients of a service provider to locate other conveniently located service providers for said clients' other interests.

It is another object of the present invention to provide a method of incentive distribution for cross client referrals that provides service providers with a free means of advertising.

It is another object of the present invention to provide a method of incentive distribution for cross client referrals that provides the central manager facilitating this method invention with a monetary incentive from the referred service provider when they obtain a new client from a referring service provider through said central manager's referral system.

It is another object of the present invention to provide a method of incentive distribution for cross client referrals that provides the central manager facilitating this method invention with increased client traffic through said central manager's referral system.

It is another object of the present invention to provide a method of incentive distribution for cross client referrals that locates service providers within a suitably close distance to an urban location.

It is another object of the present invention to provide a method of incentive distribution for cross client referrals that allows service providers to join the central manager's referral system at no cost.

It is another object of the present invention to provide a method of incentive distribution for cross client referrals that allows service providers to join the central manager's referral system for a fee.

Therefore, it is an object of the present invention to overcome the previously mentioned shortcomings found in prior client generating/client referral systems and provide a method of incentive distribution for cross client referrals.

It is another object of the present invention to provide a method of incentive distribution for cross client referrals that allows a plurality of service providers to find other service providers that their client(s) may be interested in pursing.

It is another object of the present invention to provide a method of incentive distribution for cross client referrals that promotes a service provider's own services.

It is another object of the present invention to provide a method of incentive distribution for cross client referrals that provides at least one incentive for clients of one service provider to accept the services of another service provider.

It is another object of the present invention to provide a method of incentive distribution for cross client referrals that provides clients of a service provider to locate other conveniently located service providers for said clients' other interests.

It is another object of the present invention to provide a method of incentive distribution for cross client referrals that allows service providers with a free means of advertising.

It is another object of the present invention to provide a method of incentive distribution for cross client referrals that provides the central manager facilitating this method invention with a monetary incentive from the referred service provider when the referred service provider obtains a new client from a referring service provider through said central manager's referral system.

It is another object of the present invention to provide a method of incentive distribution for cross client referrals that provides the central manager facilitating this method invention with increased client traffic through said central manager's referral system.

It is another object of the present invention to provide a method of incentive distribution for cross client referrals that locates service providers within a suitably close distance to an urban location.

It is another object of the present invention to provide a method of incentive distribution for cross client referrals that allows service providers to join the central manager's referral system at no cost.

It is another object of the present invention to provide a method of incentive distribution for cross client referrals that allows service providers to join the central manager's referral system for a fee.

It is another object of the present invention to provide a client generating/client referral system and provide a method of incentive distribution for cross client referrals.

It is another object of the present invention to provide a method of incentive distribution for cross client referrals that allows a plurality of fitness centers to find other fitness centers that their client(s) may be interested in pursing.

It is another object of the present invention to provide a method of incentive distribution for cross client referrals that promotes a fitness center's own services.

It is another object of the present invention to provide a method of incentive distribution for cross client referrals that provides at least one incentive for clients of one fitness center to accept the services of another fitness center.

It is another object of the present invention to provide a method of incentive distribution for cross client referrals that allows clients of a fitness center to locate other conveniently located fitness centers for said clients' other interests.

It is another object of the present invention to provide a method of incentive distribution for cross client referrals that provides fitness centers with a free means of advertising.

It is another object of the present invention to provide a method of incentive distribution for cross client referrals that provides the central manager facilitating this method invention with a monetary incentive from the referred fitness center when they obtain a new client from a referring fitness center through said central manager's referral system.

It is another object of the present invention to provide a method of incentive distribution for cross client referrals that provides the central manager facilitating this method invention with increased client traffic through said central manager's referral system.

It is another object of the present invention to provide a method of incentive distribution for cross client referrals that locates fitness centers within a suitably close distance to an urban location.

It is another object of the present invention to provide a method of incentive distribution for cross client referrals that allows fitness centers to join the central manager's referral system at no cost.

It is another object of the present invention to provide a method of incentive distribution for cross client referrals that allows fitness centers to join the central manager's referral system for a fee.

It is another object of the present invention to provide a method for a client generation/client referral system that incorporates incentive distribution for cross client referrals, wherein said method is facilitated by at least one computing machine over a network.

It is another object of the present invention to provide a method of incentive distribution for cross client referrals that allows a plurality of service providers to find other service providers that their client(s) may be interested in pursing, wherein said method is facilitated by at least one computing machine over a network.

It is another object of the present invention to provide a method of incentive distribution for cross client referrals that promotes a service provider's own services, wherein said method is facilitated by at least one computing machine over a network.

It is another object of the present invention to provide a method of incentive distribution for cross client referrals that provides at least one incentive for clients of one service provider to accept the services of another service provider, wherein said method is facilitated by at least one computing machine over a network.

It is another object of the present invention to provide a method of incentive distribution for cross client referrals that provides clients of a service provider to locate other conveniently located service providers for said clients' other interests, wherein said method is facilitated by at least one computing machine over a network.

It is another object of the present invention to provide a method of incentive distribution for cross client referrals that provides service providers with a free means of advertising, wherein said method is facilitated by at least one computing machine over a network.

It is another object of the present invention to provide a method of incentive distribution for cross client referrals that provides the central manager facilitating this method invention with a monetary incentive from the referred service provider when they obtain a new client from a referring service provider through said central manager's referral system, wherein said method is facilitated by at least one computing machine over a network.

It is another object of the present invention to provide a method of incentive distribution for cross client referrals that provides the central manager facilitating this method invention with increased client traffic through said central manager's referral system, wherein said method is facilitated by at least one computing machine over a network.

It is another object of the present invention to provide a method of incentive distribution for cross client referrals that locates service providers within a suitably close distance to an urban location, wherein said method is facilitated by at least one computing machine over a network.

It is another object of the present invention to provide a method of incentive distribution for cross client referrals that allows service providers to join the central manager's referral system at no cost, wherein said method is facilitated by at least one computing machine over a network.

It is another object of the present invention to provide a method of incentive distribution for cross client referrals that allows service providers to join the central manager's referral system for a fee, wherein said method is facilitated by at least one computing machine over a network.

It is another object of the present invention to provide a client generating/client referral system and provide a method of incentive distribution for cross client referrals, wherein said method is facilitated by at least one computing machine over a network.

It is another object of the present invention to provide a method of incentive distribution for cross client referrals that allows a plurality of fitness centers to find other fitness centers that their client(s) may be interested in pursing, wherein said method is facilitated by at least one computing machine over a network.

It is another object of the present invention to provide a method of incentive distribution for cross client referrals that promotes a fitness center's own services, wherein said method is facilitated by at least one computing machine over a network.

It is another object of the present invention to provide a method of incentive distribution for cross client referrals that provides at least one incentive for clients of one fitness center to accept the services of another fitness center, wherein said method is facilitated by at least one computing machine over a network.

It is another object of the present invention to provide a method of incentive distribution for cross client referrals that allows clients of a fitness center to locate other conveniently located fitness centers for said clients' other interests, wherein said method is facilitated by at least one computing machine over a network.

It is another object of the present invention to provide a method of incentive distribution for cross client referrals that provides fitness centers with a free means of advertising, wherein said method is facilitated by at least one computing machine over a network.

It is another object of the present invention to provide a method of incentive distribution for cross client referrals that provides the central manager facilitating this method invention with a monetary incentive from the referred fitness center when they obtain a new client from a referring fitness center through said central manager's referral system, wherein said method is facilitated by at least one computing machine over a network.

It is another object of the present invention to provide a method of incentive distribution for cross client referrals that provides the central manager facilitating this method invention with increased client traffic through said central manager's referral system, wherein said method is facilitated by at least one computing machine over a network.

It is another object of the present invention to provide a method of incentive distribution for cross client referrals that locates fitness centers within a suitably close distance to an urban location, wherein said method is facilitated by at least one computing machine over a network.

It is another object of the present invention to provide a method of incentive distribution for cross client referrals that allows fitness centers to join the central manager's referral system at no cost, wherein said method is facilitated by at least one computing machine over a network.

It is another object of the present invention to provide a method of incentive distribution for cross client referrals that allows fitness centers to join the central manager's referral system for a fee, wherein said method is facilitated by at least one computing machine over a network.

It is another object of the present invention to provide a method for a client generation/client referral system that incorporates incentive distribution for cross client referrals, wherein said method is facilitated by at least one computing machine over the Internet.

It is another object of the present invention to provide a method of incentive distribution for cross client referrals that allows a plurality of service providers to find other service providers that their client(s) may be interested in pursing, wherein said method is facilitated by at least one computing machine over the Internet.

It is another object of the present invention to provide a method of incentive distribution for cross client referrals that promotes a service provider's own services, wherein said method is facilitated by at least one computing machine over the Internet.

It is another object of the present invention to provide a method of incentive distribution for cross client referrals that allows at least one incentive for clients of one service provider to accept the services of another service provider, wherein said method is facilitated by at least one computing machine over the Internet.

It is another object of the present invention to provide a method of incentive distribution for cross client referrals that provides clients of a service provider to locate other conveniently located service providers for said clients' other interests, wherein said method is facilitated by at least one computing machine over the Internet.

It is another object of the present invention to provide a method of incentive distribution for cross client referrals that provides service providers with a free means of advertising, wherein said method is facilitated by at least one computing machine over the Internet.

It is another object of the present invention to provide a method of incentive distribution for cross client referrals that provides the central manager facilitating this method invention with a monetary incentive from the referred service provider when they obtain a new client from a referring service provider through said central manager's referral system, wherein said method is facilitated by at least one computing machine over the Internet.

It is another object of the present invention to provide a method of incentive distribution for cross client referrals that provides the central manager facilitating this method invention with increased client traffic through said central manager's referral system, wherein said method is facilitated by at least one computing machine over the Internet.

It is another object of the present invention to provide a method of incentive distribution for cross client referrals that locates service providers within a suitably close distance to an urban location, wherein said method is facilitated by at least one computing machine over the Internet.

It is another object of the present invention to provide a method of incentive distribution for cross client referrals that allows service providers to join the central manager's referral system at no cost, wherein said method is facilitated by at least one computing machine over the Internet.

It is another object of the present invention to provide a method of incentive distribution for cross client referrals that allows service providers to join the central manager's referral system for a fee, wherein said method is facilitated by at least one computing machine over the Internet.

It is another object of the present invention to provide a client generating/client referral system and provide a method of incentive distribution for cross client referrals, wherein said method is facilitated by at least one computing machine over the Internet.

It is another object of the present invention to provide a method of incentive distribution for cross client referrals that allows a plurality of fitness centers to find other fitness centers that their client(s) may be interested in pursing, wherein said method is facilitated by at least one computing machine over the Internet.

It is another object of the present invention to provide a method of incentive distribution for cross client referrals that promotes a fitness center's own services, wherein said method is facilitated by at least one computing machine over the Internet.

It is another object of the present invention to provide a method of incentive distribution for cross client referrals that provides at least one incentive for clients of one fitness center to accept the services of another fitness center, wherein said method is facilitated by at least one computing machine over the Internet.

It is another object of the present invention to provide a method of incentive distribution for cross client referrals that allows clients of a fitness center to locate other conveniently located fitness centers for said clients' other interests, wherein said method is facilitated by at least one computing machine over the Internet.

It is another object of the present invention to provide a method of incentive distribution for cross client referrals that allows fitness centers with a free means of advertising, wherein said method is facilitated by at least one computing machine over the Internet.

It is another object of the present invention to provide a method of incentive distribution for cross client referrals that allows the central manager facilitating this method invention with a monetary incentive from the referred fitness center when they obtain a new client from a referring fitness center through said central manager's referral system, wherein said method is facilitated by at least one computing machine over the Internet.

It is another object of the present invention to provide a method of incentive distribution for cross client referrals that allows the central manager facilitating this method invention with increased client traffic through said central manager's referral system, wherein said method is facilitated by at least one computing machine over the Internet.

It is another object of the present invention to provide a method of incentive distribution for cross client referrals that locates fitness centers within a suitably close distance to an urban location, wherein said method is facilitated by at least one computing machine over the Internet.

It is another object of the present invention to provide a method of incentive distribution for cross client referrals that allows fitness centers to join the central manager's referral system at no cost, wherein said method is facilitated by at least one computing machine over the Internet.

It is another object of the present invention to provide a method of incentive distribution for cross client referrals that allows fitness centers to join the central manager's referral system for a fee, wherein said method is facilitated by at least one computing machine over the Internet.

These together with other objects of the invention, along with various features of novelty which characterize the invention, are pointed out with particularity in the claims and Detailed Description of the Embodiments Sections, and drawings of this application, with all said sections also adding to this disclosure.

### BRIEF DESCRIPTION OF THE DRAWINGS

FIG. 1 illustrates a diagram showing the various components of the instant method invention and their relations to each other.

### DETAILED DESCRIPTION OF THE DISCLOSED EMBODIMENTS

The detailed description set forth below in connection with the appended drawing is intended as a description of presently preferred embodiments of the invention and does not represent the only forms in which the present invention may be constructed and/or utilized. The description sets forth the functions and the sequence of steps for implementing the method set forth in the instant invention. However, it is to be understood that the same or equivalent functions and sequences may be accomplished by different embodiments that are also intended to be encompassed within the spirit and scope of the invention, such as implementing methods that include providing direct and indirect payments to a service provider, central manager facilitating this method and clients as well as methods providing that said payments are flat rate or percentage based. Also alternative embodiments of the instant invention are intended to encompass service providers that provide any form of service to a client.

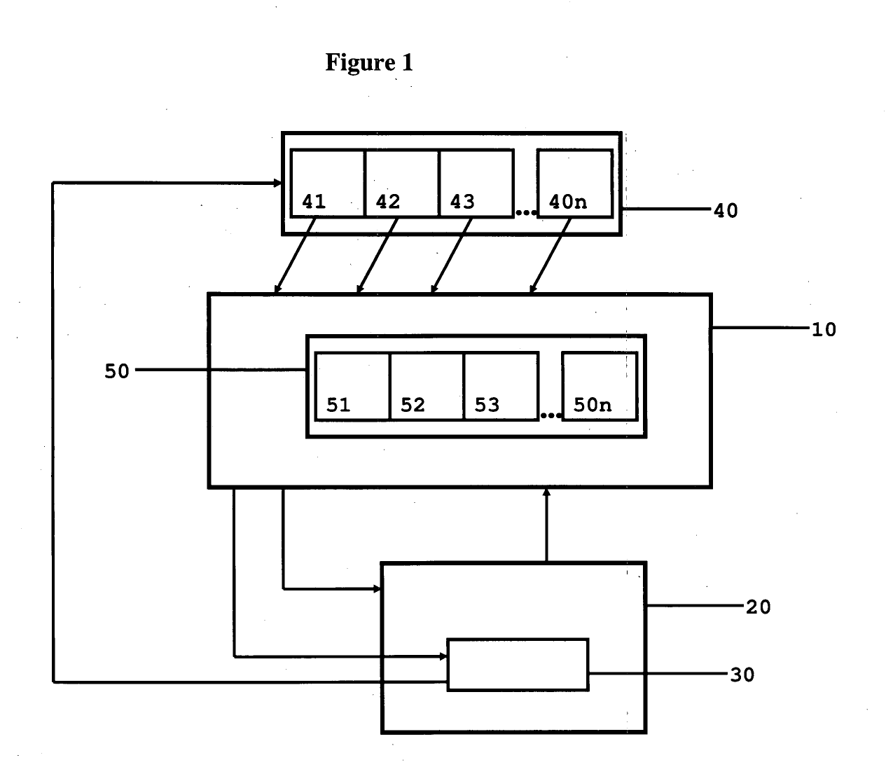

FIG. 1 illustrates the various elements proposed in the instant invention and their relations to one another. As show in FIG. 1, a central manager 10 maintains a service provider data base 50, wherein said service provider database 50 comprises a series of entries 51, 52, 53, . . . 50n that refer to a set of service providers 40, wherein said set of service providers comprises at least one service provider 41, 42, 43, . . . 40n. Also illustrated in FIG. 1 is an initiating service provider 20 who has at least one client 30 that may be interested in obtaining some of the services of other service providers located within a certain distance from or within a proximity to said central manager 10 (said certain distance may be measured in terms of physical distance and/or time necessary for said at least one client 30 to reach said other service providers).

The interaction of the elements illustrated in FIG. 1 and described in the paragraph above paragraph is such that an initiating service provider 20 proposes to said at least one client 30 that said initiating service provider 20 can refer said at least one client 30 to at least one service provider 41, 42, 43, . . . 40n and obtain some form of incentive to said at least one client 30 for signing up with at least one member of said at least one service provider 41, 42, 43, . . . 40n. Upon an affirmative response from said at least one client 30, the initiating service provider 20 begins to search for other service providers that may be of interest to said at least one client. This search is performed by said initiating service provider 20 contacting said central manager 10 to ascertain what other service providers contained within said service provider database 50 are available within a given distance acceptable to said at least one client 10 (note: contact may be made by any form of communication, including but not limited to telephone, facsimile, Internet, Intranet, network, World Wide Web, email, mail, parcel delivery service and/or direct personal communication).

Upon discovering at least one member of said at least one service provider 41, 42, 43, . . . 40n that is acceptable to said at least one client 30, said at least one client 30 may then sign up with said at least one member of said at least one service provider 41, 42, 43, . . . 40n. Further at this time said at least one client 30 must inform said at least one member of said at least one service provider 41, 42, 43, . . . 40n that they are doing so through the incentive service provided by said central manager 10 (note, that any and/or all members of said at least one service provider 41, 42, 43, . . . 40n may provide their own incentives to said at least one client to request that they join).

After said at least one client 30 joins said at least one member of said at least one service provider 41, 42, 43, . . . 40n, said at least one member of said at least one service provider 41, 42, 43, . . . 40n sends an incentive to said central manager 10. After receiving said incentive, said central manager allocates a first portion of said incentive to said initiating service provider 20 (thereby providing an incentive to provide referrals to members of said set of service providers 40). In addition, said central manager allocates a second portion of said incentive to said at least one client 30 (thereby providing a guaranteed incentive to said at least one client).

Note other embodiments of the instant method invention, the initiating service provider 20 may provide said central manager 10 with an additional incentive that the central manager may allocate a portion to said at least one client 30 and/or allocate a portion of said incentive to itself. In yet another embodiment of the instant invention said central manager 10 may allocate a third portion of said incentive provided by said at least one member of said at least one service provider 41, 42, 43, . . . 40n. In other embodiments of the instant invention the entire incentive provided by either said initiating service provider 20 and/or said at least one member of said at least one service provider 41, 42, 43, . . . 40n may be allocated to said at least one client 30 and/or to said central manager. In addition, in alternative embodiments of the instant invention said central manager 10 may also provide an incentive to said at least one client, said initiating service provider 20 and/or said at least one member of said at least one service provider 41, 42, 43, . . . 40n. Yet other embodiments allow for the execution of the instant method invention through the assistance of at least one computing machine, either individually or networked together.

One specific embodiment of the instant method invention encompassed within the scope of the instant method invention includes instances wherein the initiating service provider 20 and the set of service providers 40 comprise fitness related service providers. Other embodiment of the instant invention includes instances wherein the initiating service provider 20 and the set of service providers 40 comprise legal services, accounting services, entertainment services, technical services and/or all other consumer and professional services that are provided by society now in existence.

What is claimed is:

1. A method of incentive distribution for cross client referral, wherein said method comprises the steps of:
providing a central manager with a database, wherein said data base comprises at least one set of entry data for each member of a group of at least one service provider;
performing, by at least one initiating service provider, a search to find at least one other service provider that is desirable to at least one client;
entering, by said at least one client, into a business arrangement with at least one member of said group of at least one service provider; and
transferring, by said at least one member of said group of at least one service provider, to said central manager at least one divisible fungible commodity of value.

2. The method of incentive distribution for cross client referral of claim 1, wherein said method further comprises a step of allocating, by said central manager, at least a portion of said at least one divisible fungible commodity of value to said at least one client.

3. The method of incentive distribution for cross client referral of claim 2, wherein said method further comprises a step of said allocating, by central manager, at least a portion of said at least one divisible fungible commodity of value to said at least one initiating service provider.

4. The method of incentive distribution for cross client referral of claim 3, wherein said method further comprises a step of providing information to said central manager, by said at least one member of said group of at least one service provider and thereby informing said at least one initiating service provider and said at least one client when said step of at least one initiating service provider performing a search to find at least one other service provider that is desirable to at least one client is performed, that at least one divisible fungible commodity of value is transferrable to said at least one client upon completion of said step of said at least one client entering into a business arrangement with at least one member of said group of at least one service provider.

5. The method of incentive distribution for cross client referral of claim 4, wherein said method further comprises a step of transferring at least one divisible fungible commodity of value to said at least one client upon completion of said step of said at least one client entering into a business arrangement with at least one member of said group of at least one service provider.

6. The method of incentive distribution for cross client referral of claim 5, wherein said method further comprises a step of informing said at least one client that at least one divisible fungible commodity of value is transferrable to said at least one client upon completion of said step of said at least one client entering into a business arrangement with at least one member of said group of at least one service provider.

7. A method of incentive distribution for cross client referral, wherein said method comprises the steps of:
providing a central manager with a database, wherein said data base comprises at least one set of entry data for each member of a group of at least one service provider and is accessible over a computing machine network;
performing a search to find at least one other service provider that is desirable to at least one client, by at least one initiating service provider, wherein said search to find at least one other service provider that is desirable to at least one client further comprises the step of logging into said computing machine network and searching on said computing machine network for an entry substantially corresponding to said at least one other service provider that is desirable to said at least one client;
entering into a business arrangement with at least one member of said group of at least one service provider by said at least one client; and
transferring to said central manager at least one divisible fungible commodity of value by said at least one member of said group of at least one service provider.

8. The method of incentive distribution for cross client referral of claim 7, wherein said step of said at least one client entering into a business arrangement with at least one member of said group of at least one service provider further comprises a step of transferring, by said at least one client to said at least one member of said group of at least one service provider at least one divisible fungible commodity of value and wherein said method further comprises a step of said central manager allocating at least a portion of said at least one divisible fungible commodity of value to said at least one client. wherein said at least a portion of said at least one divisible fungible commodity of value comprises a percentage of a fee said at least one client transfers to said at least one member of said group of at least one service provider.

9. The method of incentive distribution for cross client referral of claim 8, wherein said method further comprises a step of allocating at least a portion of said at least one divisible fungible commodity of value to said at least one initiating service provider, by said central manager.
the method of incentive distribution for cross client referral of claim 9, wherein said method further comprises a step of said at least one member of said group of at least one service provider of providing information to said central manager, and thereby informing said at least one initiating service provider and said at least one client when said step of at least one initiating service provider performing a search to find at least one other service provider that is desirable to at least one client is performed, that at least one divisible fungible commodity of value is transferrable to said at least one client upon completion of said step of said at least one client entering into a business arrangement with at least one member of said group of at least one service provider.

10. The method of incentive distribution for cross client referral of claim 10, wherein said method further comprises a step of said central manager transferring at least one divisible fungible commodity of value to said at least one client upon completion of said step of said at least one client entering into a business arrangement with at least one member of said group of at least one service provider.

11. The method of incentive distribution for cross client referral of claim 11, wherein said method further comprises a step of informing said at least one client that at least one divisible fungible commodity of value is transferable to said at least one client upon completion of said step of said at least one client entering into a business arrangement with at least one member of said group of at least one service provider.

12. The method of incentive distribution for cross client referral of claim 12, wherein said method further comprises a step of wherein said method further comprises a step of updating said at least one database by inputting data reflecting that said at least one client is now in a business arrangement with at least one member of said group of at least one service provider to said business arrangement.

14. A method of incentive distribution for cross client referral, wherein said method comprises the steps of:
providing a central manager with a database, wherein said data base comprises at least one set of entry data for each member of a group of at least one service provider and is accessible over a computing machine network such as the Internet;
performing a search to find at least one other service provider that is desirable to at least one client, by at least one initiating service provider, wherein said search to find at least one other service provider that is desirable to at least one client further comprises the step of logging into said computing machine network such as the Internet, wherein said computing machine network is available by login through a World Wide Web page and searching on said computing machine network for an entry substantially corresponding to said at least one other service provider that is desirable to said at least one client;
entering into a business arrangement with at least one member of said group of at least one service provider, by said at least one client; and
transferring to said central manager at least one divisible fungible commodity of value, by said at least one member of said group of at least one service provider.

15. The method of incentive distribution for cross client referral of claim 14, wherein said step of said at least one client entering into a business arrangement with at least one member of said group of at least one service provider further comprises a step of transferring to said at least one member of said group of at least one service provider at least one divisible fungible commodity of value, by said at least one client and, wherein said method further comprises a step of allocating at least a portion of said at least one divisible fungible commodity of value to said at least one client, by said central manager. wherein said at least a portion of said at least one divisible fungible commodity of value comprises at least one member of a group consisting of a percentage of a fee said at least one client transfers to said at least one member of said group of at least one service provider and a flat rate fee.

16. The method of incentive distribution for cross client referral of claim 15, wherein said method further comprises a step of allocating at least a portion of said at least one divisible fungible commodity of value to said at least one initiating service provider, by said central manager, wherein said at least a portion of said at least one divisible fungible commodity of value comprises at least one member of a group consisting of a percentage of a fee, wherein said at least one client transfers to said at least one member of said group of at least one service provider and a flat rate fee.

17. The method of incentive distribution for cross client referral of claim 16, wherein said method further comprises a step of providing information to said central manager, and thereby informing said at least one initiating service provider and said at least one client when said step of at least one initiating service provider performing a search to find at least one other service provider that is desirable to at least one client is performed, that at least one divisible fungible commodity of value is transferrable to said at least one client upon completion of said step of said at least one client entering into a business arrangement with at least one member of said group of at least one service provider, and informing said at least one client that said at least a portion of said at least one divisible fungible commodity of value comprises at least one member of a group consisting of a percentage of a fee said at least one client transfers to said at least one member of said group of at least one service provider and a flat rate fee, by said at least one member of said group of at least one service provider.

18. The method of incentive distribution for cross client referral of claim 17, wherein said method further comprises a step of transferring at least one divisible fungible commodity of value to said at least one client upon completion of said step of said at least one client entering into a business arrangement with at least one member of said group of at least one service provider by said central manager, wherein said at least a portion of said at least one divisible fungible commodity of value comprises at least one member of a group consisting of a percentage of a fee said at least one client transfers to said at least one member of said group of at least one service provider and a flat rate fee.

19. The method of incentive distribution for cross client referral of claim 18, wherein said method further comprises a step of informing said at least one client that at least one divisible fungible commodity of value is transferrable to said at least one client upon completion of said step of said at least one client entering into a business arrangement with at least one member of said group of at least one service provider.

20. The method of incentive distribution for cross client referral of claim 19, wherein said method further comprises a step of updating said at least one database by inputting data reflecting that said at least one client is now in a business arrangement with at least one member of said group of at least one service provider to said business arrangement, wherein access to said computing machine network is available by logging in through a World Wide Web page and searching on said computing machine network for an entry substantially corresponding to said at least one other service provider that is desirable to said at least one client.
